(19) United States
(12) Patent Application Publication
(10) Pub. No.: US 2009/0193021 A1
(43) Pub. Date: Jul. 30, 2009

(54) CAMERA SYSTEM AND METHOD FOR PICTURE SHARING BASED ON CAMERA PERSPECTIVE

(76) Inventors: Vikram M. Gupta, Cary, NC (US); Srinivas Annambhotla, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/021,853

(22) Filed: Jan. 29, 2008

(51) Int. Cl. G06F 17/30

(52) U.S. Cl. 707/6; 707/E17.014

(57) ABSTRACT

An electronic device may transmit point-of-view information to a server that searches an image database for images that were taken from a corresponding point-of-view. Matching images may be displayed to a user of the electronic device and the user may be provided with an option to save one or more of the matching images in place of or in addition to a picture that was captured with the electronic device.

### TECHNICAL FIELD OF THE INVENTION

The technology of the present disclosure relates generally to photography and, more particularly, to a camera system and method that allows a user to obtain an image from a database that has perspective characteristics that correspond to perspective characteristics of the camera system.

### BACKGROUND

Mobile and/or wireless electronic devices are becoming increasingly popular. For example, mobile telephones, portable media players and portable gaming devices are now in wide-spread use. In addition, the features associated with certain types of electronic devices have become increasingly diverse. For example, many mobile telephones now include cameras that are capable of capturing still images and video images. Some of these cameras are capable of taking relatively high quality pictures. For example, some current camera phones have five to six megapixel camera systems.

To improve picture quality, some camera systems are capable of taking several pictures in rapid succession where each picture is taken with slightly different camera exposure settings. The user then may review the pictures and select the “best” picture from the group to save. This feature is limited to the pictures that are taken with the user's camera. Therefore, if the lighting conditions are not optimal (e.g., if the day is foggy or “gloomy”), then none of the images in the series of pictures may be to the user's liking.

### SUMMARY

To provide an alternative to storing a user-taken picture, the present disclosure describes an option where the user may store a picture from a picture database that was taken from a perspective that corresponds to the perspective of the user's camera. For instance, on a day where lighting conditions are not favorable to taking a memorable picture (e.g., on an overcast day where the user has difficulty in taking a “sunny” shot of the subject), the camera system may present an alternative a picture (or pictures) that was taken with a different camera and a different time (e.g., a different day), but with the same or similar perspective. The user may review the alternative picture and elect to store the alternative picture in addition to or instead of the picture that the user's camera captured.

According to one aspect of the disclosure, a first method provides a way to share a digital image. The first method may include receiving point-of-view information that indicates a relationship between an electronic device and a scene, the point-of-view information including location information for the electronic device and aiming direction information for the electronic device; and searching an image database for an image that is associated with a point-of-view that corresponds to the point-of-view information for the electronic device.

According to one embodiment, the first method further includes transmitting an image from the image database to the electronic device, the transmitted image associated with a point-of-view that corresponds to the point-of-view information for the electronic device.

According to one embodiment of the first method, the direction information includes a compass direction and an elevation.

According to one embodiment of the first method, the point-of-view information further includes altitude information for the electronic device.

According to one embodiment, the first method further includes receiving date information from the electronic device and the searching includes searching the image database for an image that has an associated date that corresponds to the received date information.

According to one embodiment, the first method further includes receiving date information from the electronic device and the searching includes searching the image database for an image that has an associated date that is different than the received date information so that a matched image of the scene has potential to have noticeably different visual attributes.

According to one embodiment, the first method further includes receiving time of day information from the electronic device and the searching includes searching the image database for an image that has an associated time of day that corresponds to the received time of day information.

According to one embodiment, the first method further includes receiving time of day information from the electronic device and the searching includes searching the image database for an image that has an associated time of day that is different than the received time of day information so that a matched image of the scene has potential to have noticeably different visual attributes.

According to one embodiment, the first method further includes maintaining a user selection score for each image of the image database and the searching including prioritizing search results based on the corresponding user selection scores.

According to one embodiment, the first method further includes receiving an image of the scene and point-of-view information associated with the image from the electronic device and adding the image and associated point-of-view information to the image database.

According to another aspect of the disclosure, a second method provides a way to obtain a digital image with an electronic device. The second method may include generating point-of-view information that indicates a relationship between the electronic device and a scene, the point-of-view information including location information for the electronic device and aiming direction information for the electronic device; transmitting the point-of-view information to a server that searches an image database for an image that is associated with a point-of-view that corresponds to the point-of-view information for the electronic device; and receiving the digital image from the server, the received image having an associated point-of-view that corresponds to the point-of-view information generated by the electronic device.

According to one embodiment of the second method, the direction information includes a compass direction and an elevation.

According to one embodiment of the second method, the point-of-view information further includes altitude information for the electronic device.

According to one embodiment, the second method further includes transmitting at least one of date information or time of day information to the server.

According to one embodiment of the second method, multiple images are received from the server and the method further includes selecting one or more of the images for storage.

According to one embodiment, the second method further includes taking a digital picture of the scene with the electronic device.

According to one embodiment, the second method further includes substituting the digital picture taken with the electronic device with the received image.

According to one embodiment, the second method further includes transmitting the digital picture taken with the electronic device to the server.

According to one embodiment, the second method further includes combining image data from the digital picture taken with the electronic device with image data from the received image to generate a composite image.

According to one embodiment of the second method, the image data from the digital picture taken with the electronic device present in the composite image is recognized as corresponding to objects that are unique to the digital picture taken with the electronic device.

According to one embodiment of the second method, the electronic device includes a camera assembly.

According to one embodiment of the second method, the electronic device does not include a camera assembly.

According to another aspect of the disclosure, an electronic device includes one or more components that output data relating to a point-of-view of the electronic device; a radio circuit used to establish a wireless interface with a network to exchange data with a server; and a controller. The controller generates point-of-view information from the data of the one or more components, the point-of-view information indicative of a relationship between an electronic device and a scene, and the point-of-view information including location information for the electronic device and aiming direction information for the electronic device; and controls the radio circuit to transmit the point-of-view information to the server for the server to conduct a search of an image database for an image that is associated with a point-of-view that corresponds to the point-of-view information for the electronic device. The electronic device receives a digital image from the server, the received image having an associated point-of-view that corresponds to the point-of-view information generated by the controller.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIGS. 1 and 2 are respectively a front view and a rear view of an exemplary electronic device that includes a representative camera assembly;

FIG. 3 is a schematic block diagram of the exemplary electronic device of FIGS. 1 and 2;

FIG. 4 is a schematic diagram of a communications system in which the electronic device may operate;

FIG. 5 is a flow diagram of steps carried out by the electronic device to implement a method of sharing a picture based on camera perspective;

FIG. 6 is a flow diagram of steps carried out by a server of the communications system to implement a method of sharing a picture based on camera perspective;

FIG. 7 is a representative picture taken with the camera assembly of the electronic device;

FIGS. 8 through 10 are representative alternative images that have a point-of-view match with the picture of FIG. 7;

FIGS. 11 through 14 are representative alternative images that are of the same scene as the picture of FIG. 7, but have a different point-of view; and

FIG. 15 is a representative alternative image that has a point-of-view that does not match the point-of-view of the picture of FIG. 7.

### DETAILED DESCRIPTION OF EMBODIMENTS

Embodiments will now be described with reference to the drawings, wherein like reference numerals are used to refer to like elements throughout. It will be understood that the figures are not necessarily to scale.

Described below in conjunction with the appended figures are various embodiments of an improved camera system and method of camera operation. In the illustrated embodiments, the camera system is embodied as a digital camera assembly that is made part of a mobile telephone. It will be appreciated that aspects of the camera system may be applied to other operational contexts such as, but not limited to, a dedicated camera or another type of electronic device that has a camera (e.g., a personal digital assistant (PDA), a media player, a gaming device, a computer, etc.). The camera assembly may be used to capture image data in the form of still images, also referred to as pictures and photographs, but it will be understood that the camera assembly may be capable of capturing video images in addition to still images. As described below, aspects of the disclosure may be carried out by an electronic device that does not include a camera assembly.

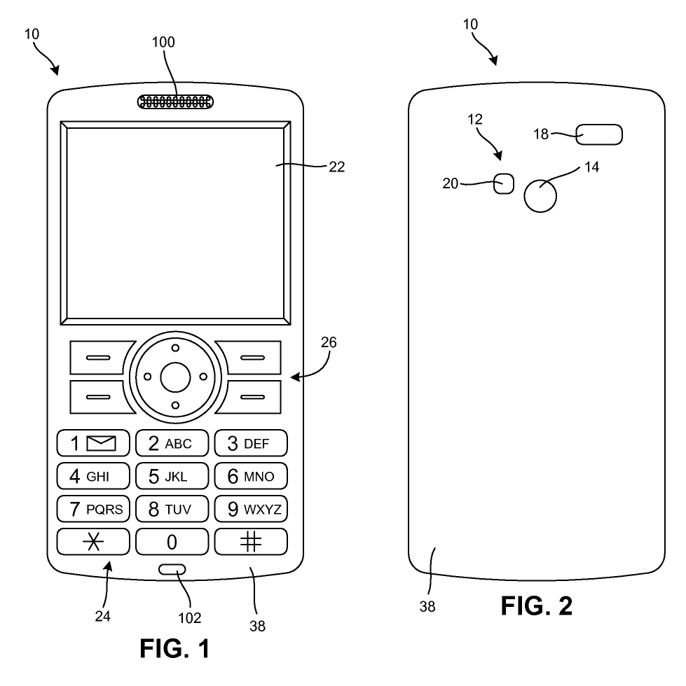

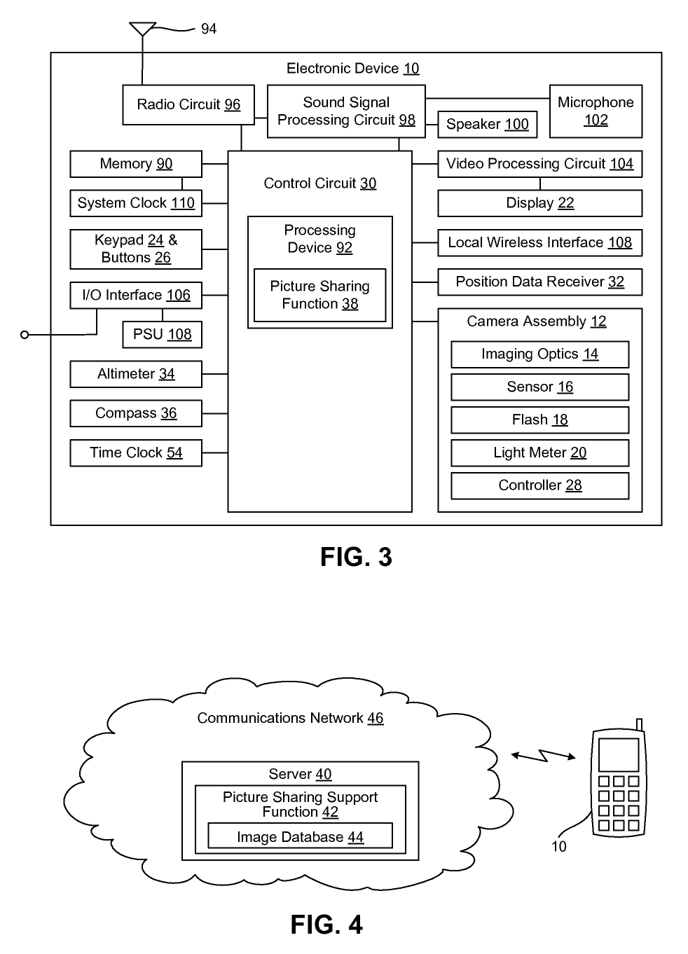

Referring initially to FIGS. 1 through 3, an electronic device 10 is shown. The illustrated electronic device 10 is a mobile telephone. The electronic device 10 includes a camera assembly 12 for taking digital still pictures and/or digital video clips. It is emphasized that the electronic device 10 need not be a mobile telephone, but could be a dedicated camera or some other device as indicated above.

The camera assembly 12 may be arranged as a typical camera assembly that includes imaging optics 14 to focus light from a scene within the field-of-view of the camera assembly 12 onto a sensor 16. The sensor 16 converts the incident light into image data. The imaging optics 14 may include various optical components, such as a lens assembly and components that supplement the lens assembly (e.g., a protective window, a filter, a prism, and/or a mirror). The imaging optics 14 may be associated with focusing mechanics, focusing control electronics (e.g., a multi-zone autofocus assembly), optical zooming mechanics, etc. Other camera assembly 12 components may include a flash 18 to provide supplemental light during the capture of image data for a photograph, a light meter 20, a display 22 for functioning as an electronic viewfinder and as part of an interactive user interface, a keypad 24 and/or buttons 26 for accepting user inputs, an optical viewfinder (not shown), and any other components commonly associated with cameras. One of the keys from the keypad 24 or one of the buttons 26 may be a shutter key that the user may depress to command the taking of a photograph.

Another component of the camera assembly 12 may be an electronic controller 28 that controls operation of the camera assembly 12. The controller 28 may be embodied, for example, as a processor that executes logical instructions that are stored by an associated memory, as firmware, as an arrangement of dedicated circuit components, or as a combination of these embodiments. Thus, methods of operating the camera assembly 12 may be physically embodied as executable code (e.g., software) that is stored on a machine readable medium or may be physically embodied as part of an electrical circuit. In another embodiment, the functions of the electronic controller 28 may be carried out by a control circuit 30 that is responsible for overall operation of the electronic device 10. In this case, the controller 28 may be omitted. In another embodiment, camera assembly 12 control functions may be distributed between the controller 28 and the control circuit 30.

It will be understood that the sensor 16 may capture data at a predetermined frame rate to generate a preview video signal that is supplied to the display 22 for operation as an electronic viewfinder. Typically, the display 22 is on an opposite side of the electronic device 10 from the imaging optics 14. In this manner, a user may point the camera assembly 12 in a desired direction and view a representation of the field-of-view of the camera assembly 12 on the display 22. As such, the camera assembly 12 may have a point-of-view, or perspective. The point-of-view is a combination of a location of the camera assembly 12 and a direction in which the camera assembly 12 is aimed by the user. The point-of-view of the camera assembly 12, in combination with characteristics of the imaging optics 14 and optical settings, such as an amount of zoom, establish the field-of-view of the camera assembly.

In one embodiment, the electronic device 10 includes components (e.g., one or more sensors) that may be used to determine the point-of-view of the camera assembly 12 at a given moment in time, such as when the user commands the taking of a picture. For example, the electronic device 10 may include a position data receiver 32, such as a global positioning system (GPS) receiver, Galileo satellite system receiver or the like. The position data receiver 32 may be involved in determining the location of the electronic device 10. The location data received by the position data receiver 32 may be processed to derive a location value, such as coordinates expressed using a standard reference system (e.g., the world geodetic system or WGS). Also, assisted-GPS (or A-GPS) may be used to determine the location of the electronic device 10. A-GPS uses an assistance server, which may be implemented with a server of a communications network in which the electronic device 10 operates. The assistance server processes location related data and accesses a reference network to speed location determination and transfer processing tasks from the electronic device 10 to the server. For instance, the assistance server may perform tasks to make range measurements and calculate position solutions that would otherwise be carried out by the position data receiver or elsewhere in the electronic device 10. Location may be determined in other manners. For instance, under global system mobile communications (GSM) and universal mobile telecommunications system (UMTS) protocols, the position could be estimated through a mobile originated location request (MO-LR) to the network so that the electronic device 10 position could be estimated using the network's knowledge of base station locations and antenna directions.

Another component that may generate data that is useful in determining the point-of-view of the camera assembly 12 may be an altimeter 34. The altimeter 34 may provide information regarding the altitude of the electronic device 10, such as a height value relative to sea level. In other embodiments, a GPS location determination may include ascertaining altitude information.

Another component that may generate data that is useful in determining the point-of-view of the camera assembly 12 may be a digital compass 36. The digital compass 36 may generate information regarding the direction in which the camera assembly 12 is pointed. The direction information may include a compass direction (e.g., north, east, west and south, and any direction between these four references) and an elevation (e.g., a positive or negative angle valve with respect to horizontal).

Using a combination of the location information, the direction information and, if desired, the altitude information, the point of the view of the camera assembly 12 may be ascertained.

The electronic device 10 may further include a picture sharing function 38 that is configured to determine the point-of-view of the camera assembly 12. Additional details and operation of the picture sharing function 38 will be described in greater detail below. The picture sharing function 38 may be embodied as executable code that is resident in and executed by the electronic device 10. In one embodiment, the picture sharing function 38 may be a program stored on a computer or machine readable medium. The picture sharing function 38 may be a stand-alone software application or form a part of a software application that carries out additional tasks related to the electronic device 10.

With additional reference to FIG. 4, the picture sharing function 38 may use the point-of-view information to obtain one or more photographs from a coordinating picture sharing support function 42 that is hosted by a server 40. As described in greater detail below, the picture sharing support function 42 may include an image database 44.

The server 40 may be part of a communications network 46 in which the electronic device 10 is configured to operate. For instance, the server 40 may manage calls placed by and destined to the electronic device 10, transmit data to the electronic device 10 and carry out other support functions. In other embodiments, the server 40 may be outside the domain of the communications network 46, but may accessible by the electronic device 10 via the communications network 46. The communications network 46 may include communications towers, access points, base stations or any other transmission medium for supporting wireless communications between the communications network 46 and the electronic device 10. The network 46 may support the communications activity of multiple electronic devices 10 and other types of end user devices. As will be appreciated, the server 40 may be configured as a typical computer system used to carry out server functions and may include a processor configured to execute software containing logical instructions that embody the functions of the picture sharing support function 42 and a memory to store such software.

Additional details and operation of the picture sharing support function 42 will be described in greater detail below. The picture sharing support function 42 may be embodied as executable code that is resident in and executed by the server 40. In one embodiment, the picture sharing support function 42 may be a program stored on a computer or machine readable medium. The picture sharing support function 42 may be a stand-alone software application or form a part of a software application that carries out additional tasks related to the server 40.

It will be apparent to a person having ordinary skill in the art of computer programming, and specifically in application programming for mobile telephones or other electronic devices, how to program the electronic device 10 to operate and carry out logical functions associated with the picture sharing function 38 and how to program the server 40 to operate and carry out logical functions associated with the picture sharing support function 42. Accordingly, details as to specific programming code have been left out for the sake of brevity. Also, while the functions 38 and 42 may be executed by respective processing devices in accordance with an embodiment, such functionality could also be carried out via dedicated hardware or firmware, or some combination of hardware, firmware and/or software.

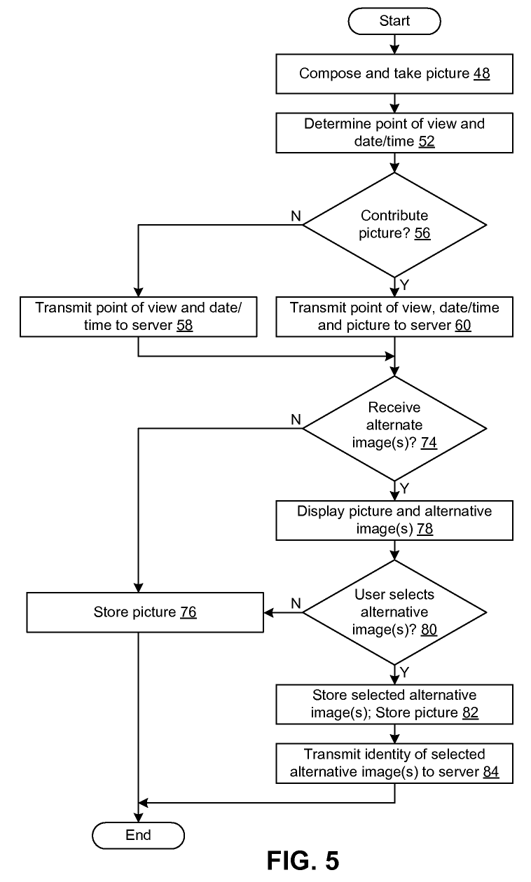

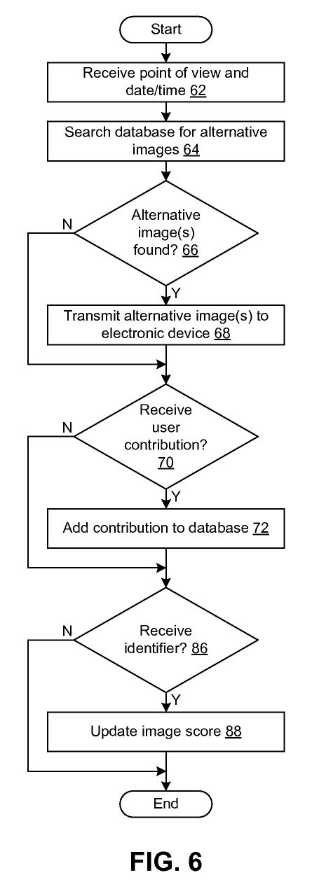

With additional reference to FIGS. 5 and 6, illustrated are logical operations to implement an exemplary method of sharing a picture based on a perspective of the camera assembly 12. The exemplary method may be carried out by executing an embodiment of the picture sharing function 38 and executing an embodiment of the picture sharing support function 42. Thus, the flow chart of FIG. 5 may be thought of as depicting steps of a method carried out by the mobile telephone 10 and the flowchart of FIG. 6 may be thought of as depicting steps of a method carried out by the server 40.

The logical operations represented by FIGS. 5 and 6 will be described in conjunction with one another to demonstrate a logical flow in accordance with an exemplary sequence of carrying out logical operations for sharing a picture. Therefore, the following description will alternate between referring to FIG. 5 and referring to FIG. 6. It will be appreciated that alternative logical flows are possible. Therefore, even though FIGS. 5 and 6 show a specific order of executing functional logic blocks, the order of executing the blocks may be changed relative to the order shown. Also, two or more blocks shown in succession may be executed concurrently or with partial concurrence. Certain blocks and/or certain portions of blocks may be omitted.

The logical flow for the picture sharing function 38 may begin in block 48 where the user may compose a picture. For example, the user may aim the camera assembly 12 so that the point-of-view of the camera assembly 12 and the field-of-view of the camera assembly 12 contain a portion of a scene that the user would like to capture in a picture. Next, the user may command the camera assembly 12 to take a picture. For instance, the user may depress a shutter release key, which results in the generation of image data for the picture by the sensor 16.

With additional reference to FIG. 7, illustrated is a representative picture 50 taken with the camera assembly 12. Since the picture 50 was taken with the camera assembly 12 under the control of the user, the picture 50 will be referred to as the “user's picture 50”. In the example of FIG. 7, the user's picture 50 is of the Statue of Liberty in New York Harbor. The point-of-view of the camera assembly at the time that the user's picture 50 was taken is from in front of the statue and from ground level aiming upward.

In block 52, the logical flow may include determining point-of-view information for the camera assembly 12 at the time that the user's picture 50 was taken. As described above, determining the point-of-view of the camera assembly 12 may include collecting and/or analyzing one or more of location information, altimeter information, compass direction information and elevation angle information. Block 52 may further include determining the date and time that the user's picture 50 was taken. For this purpose, the electronic device 10 may include a time clock 54. The time clock 54 may be implemented in hardware, firmware and/or software. The time clock 54 may track the day, such as by month, day and year, and track the time, such as by hour, minute and second. In one embodiment, the electronic device may obtain date and/or time information from the communications network 46.

The logical flow may proceed to block 56 where it is determined if the user's picture 50 is to be contributed to the image database 44. The determination may be made in a number of ways. For example, the user may be presented with a preview of the user's picture 50 on the display 22 and the user, through a graphical user interface, may choose whether to contribute the user's picture 50. In another embodiment, the determination as to whether to contribute the user's picture 50 may be based on a predetermined setting of the electronic device 10. If it is determined that the user's picture 50 will not be contributed to the image database 44, a negative determination may be made in block 56 and the logical flow may proceed to block 58.

In block 58, the electronic device 10 may transmit the point-of-view information, the date information and the time information that were determined in block 52 to the server 40. In one embodiment, the transmitted point-of-view information may be the results of processing data from the position data receiver 32, the altimeter 34 and/or the compass 36. In another embodiment, raw data from the components may be transmitted to the server 40 as the point-of-view information and the server 40 may process the information. The point-of-view information, the date information and the time information may be transmitted to the server 40 in any appropriate format, such as with a mark-up language (e.g. extensible mark-up language or XML).

If, in block 56, it is determined that the user's picture 50 is to be contributed to the image database 44, then a positive determination may be made in block 56 and the logical flow may proceed to block 60. In block 60, the electronic device 10 may transmit the point-of-view information, the date information, the time information and the user's picture 50 to the server 40.

With additional reference to FIG. 6, the server 40 may receive the point-of-view information, the date information and the time information from the electronic device 10 in block 62. Thereafter, in block 64, the picture sharing support function 42 may search the image database 44 for one or more alternative images that correspond to the point-of-view of the camera assembly 12 at the time that the user's picture 50 was taken. The search of block 64 may be undertaken using a combination of search criteria and/or the results may be prioritized using various criteria. The matching and prioritization of block 64 may be implemented to narrow down the number of images that correspond to the point-of-view of the camera assembly 12 to a few images for presentation to the user. For example, the number of images may be narrowed down to about one to about six images.

The criteria for searching and/or prioritizing the search results may include the point-of-view of the camera assembly 12, the date, the time, the popularity of images in the image database 44, image file size, picture quality, number of pixels, and other criteria. In one embodiment, the point-of-view of the camera assembly 12, as based upon the location information, altitude, compass direction and/or elevation angle may be used to find images in the image database 44 that were taken with the same point-of-view or a similar point-of-view.

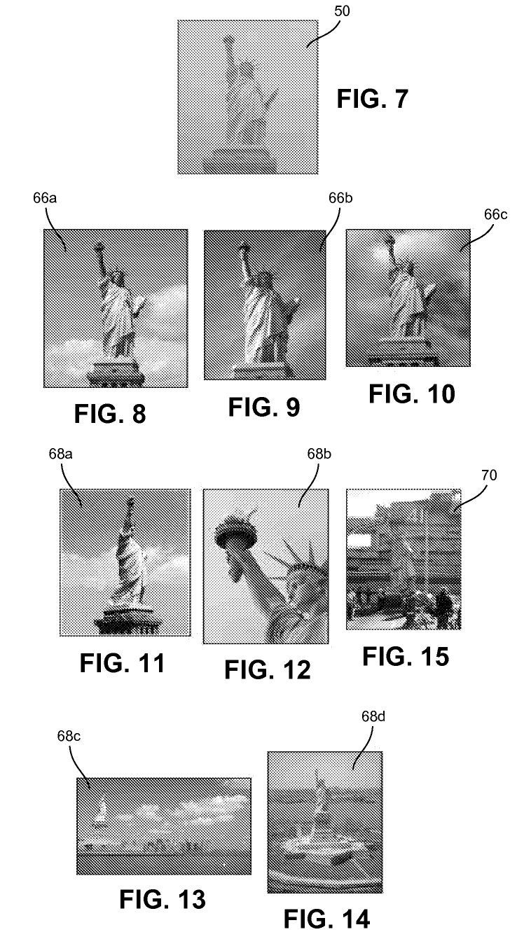

With additional reference to FIGS. 8, 9 and 10, shown are representative alternative images 66a, 66b and 66c, respectively. The representative alternative images 66 were taken by a camera or cameras positioned so as to have the same or similar point-of-view as the camera assembly 12 when the user's picture 50 was captured. Following the example of the Statue of Liberty, the alternative images 66 are taken from the ground in front of the Statue of Liberty in New York Harbor. Searching the image database 44 for images that were taken from a point-of-view that is the same as or similar to the point-of-view of the camera assembly 12 at the time that the user's picture 50 was taken may yield images that may be of the greatest interest to the user. For example, the image database 44 may contain images of the same object or scene as captured by the user's picture 50, but those images may have been taken from a different point-of-view. For instance, with additional reference to FIGS. 11 through 14, shown are representative images, 68a through 68d of the Statue of Liberty that are taken from different points of view than was used to take the user's picture 50. Provided that images that more closely match the point-of-view of the camera assembly 12 are available, images having progressively decreasing correspondence to the point-of-view of the camera assembly may be given less weight and removed from the search results.

Also, using point-of-view information may reduce the possibility that images taken in an entirely different location from the location where the user's picture 50 was taken may be filtered out of the search results. For instance, with additional reference to FIG. 15, shown is an image 70 of a scaled version of the Statue of Liberty in a city other than New York City. It is contemplated that each of the representative images from FIGS. 8 through 15 could be stored with a file name or other metadata indicating that the associated image 66, 68 or 70 is of the Statue of Liberty. Had searching been conducted based on a user-entered text string or a computer-generated text string (e.g., as generated using image or pattern recognition), the image 70 could have been included in the search results. However, using point-of-view information, it is unlikely that such an image would be included in the search results due to the differences in the respective locations.

In one embodiment, altitude information may be useful in distinguishing a point-of-view of the camera assembly 12 from other possible points of view from the same location. For instance, a user may be on a first floor of a building while attempting to capture a picture of an object or scene. This point-of-view may be different from the same relative location, but when the user is on the fourth floor of the same building. As will be appreciated, the collection of altitude information separate from location information may be omitted if the location information includes altitude information or if the location information with compass direction and elevation angle provides sufficient information for distinguishing the point-of-view of the camera assembly 12 from other possible points of view at the same location.

As indicated, other search criteria may be used in matching and/or prioritizing images from the image database 44. For example, the date and time information may be used as part of the search process. The date and time information may allow the picture sharing support function 42 to identify images that were taken at the same time of day and/or around the same date as the user's picture 50. In this manner, any identified images may have similar visual attributes to the image that the user was attempting to capture. For example, an image taken from the same or similar point-of-view and at a similar time of day may yield an image to the user's liking. Such an image may be from a date as close as possible to the current date or from a similar date from another year.

In other embodiments, the date and time may be used to identify images that are from the same or similar point-of-view, but at a different time of day and/or different date. In this manner, alternative images may be identified that show the same object or scene, but with different visual attributes, such as different lighting conditions (e.g. if the user's picture 50 was taken during the day, the alternative image may be a night time representation) or at a different season (e.g. if the user's picture 50 was taken during the summer, the alternative image may be a fall, winter or spring representation of the same scene).

Using the date and/or time information, the picture sharing support function 42 may identify images from different times of day, similar times of day, different seasons, or different days. Depending on user settings or default settings the picture sharing support function 42 may prioritize which alternative images to be shared with the user. For example, user settings may be set to attempt to identify images that most closely represent the object or scene photographed by the user in terms of typical lighting conditions and seasonal variations. Alternatively, the alternative images may be identified to provide the user with an experience from the same scene, but at different times. For example, the user may be interested in images of the same object or scene with different illumination conditions or seasonal variations such as a night representation, a day representation, a sunrise representation, a sunset representation, a sunny summer day representation, a snowy day representation, and so forth. As one example, a user may be able to experience views from a mountain top at slightly different times, such as an image of the scene with pre-fall colors, peak fall colors and post-fall colors of trees in a scene.

Following block 64, the logical flow may proceed to block 66. In block 66 a determination may be made as to whether any alternative images that meet the search criteria were found by the picture sharing support function 42. If one or more alternative images were identified, a positive determination may be made in block 66 and the logical flow may proceed to block 68. In block 68, the alternative images may be transmitted to the electronic device 10. In one embodiment, the alternative images that are transmitted to the electronic device 10 may be transmitted as thumbnails. The alternative images (e.g., as full images or as thumbnails) may be push delivered to the electronic device 10. If delivered in thumbnail format, a corresponding full image may be downloaded by user action or may be downloaded following user selection of the thumbnail. User selection of an image will be described in greater detail below. If no alternative images were identified in block 64, a negative determination may be made in block 66. In one embodiment, a message may be transmitted to the electrical device 10 to indicate that no alternative images were identified for the point-of-view of the camera assembly 12.

Following block 68, or following a negative determination in block 66, the logical flow may proceed to block 70. In block 70, a determination may be made as to whether the server 40 received the user's picture 50 as a contribution to the image database 44. If the user's picture 50 was received in block 70, a positive determination may be made and the logical flow may proceed to block 72. In block 72 the user's picture 50 may be added as an image to the image database 44 along with the associated point-of-view information, date information and time information.

With continued reference to FIG. 5, following the transmission of information to the server 40 in either of blocks 58 or 60, the logical flow may proceed to block 74 where a determination is made as to whether the electronic device has received any alternative images from the server 40. If no alternative images are received, the logical flow may proceed to block 76 where the user's picture 50 is stored. If, in block 74, one or more alternative images are received, a positive determination may be in block 74 and the logical flow may proceed to block 78 where the user's picture 50 may be displayed with the received alternative image or images. The user may browse the alternative images to determine if one or more of the images is more to the user's liking than the user's picture 50. The user may be provided with an option to save one or more of the alternative images instead of the user's picture 50 or in addition to the user's picture 50. Therefore, in block 80, a determination may be made as to whether the user has selected one or more of the alternative images to store as his or her own image of the object or scene. If the user does not select an alternative image, a negative determination may be made in block 80 and the logical flow may proceed to block 76 where a user's picture 50 is stored.

If the user does select one or more of the alternative images for storage, a positive determination may be made in block 80 and the logical flow may proceed to block 82. In block 82, the picture sharing function 38 may store the user selected alternative image. The storing of the user selected alternative image may be carried out in addition to storing the user's picture 50 or in place of storing the user's picture 50. A determination as to whether to store the user's picture 50 may be made based on user input or based on default settings. For instance, the user may be given the option to store the user's picture 50 on a picture by picture basis. In one embodiment, if the user decides to store one or more of the alternative images, the user may be charged for the image. In other embodiments, use of the picture sharing function may be free or may be based on a subscription pricing scheme.

Following block 82, the logical flow may proceed to block 84 where the electronic device 10 transmits an identity of the selected alternative image to the server 40. In one embodiment, each image of the image database 44 may be associated with a unique identifier for tracking purposes. This identifier may be transmitted with the image to the electronic device 10 so that, upon the selection of an alternative image by the user, the unique identifier for the selected image may be transmitted back to the server 40.

With continued reference to FIG. 6, following block 72 or after a negative determination in block 70, the logical flow may proceed to block 86. In block 86, a determination may be made as to whether the server 40 has received the identity of an alternative image that was selected by the user. If an identifier is received, a positive determination may be made in block 86 and the logical flow may proceed to block 88. In block 88, a user selection score associated with the corresponding image may be updated. For example, images that are frequently selected by users may be given a high user selection score and images that are not frequently selected by users may receive a low user selection score. The user selection score may be used as part of the image prioritization of block 64. For example, an image with a high user selection score may be used as a matching image ahead of an image with a low user selection score. In one embodiment, the image database 44 may be pruned by eliminating images with relatively low user selection scores.

The method described above includes taking the user's picture 50 with the camera assembly 12. It will be appreciated that the method may be modified to work with an electronic device 10 that does not include a camera assembly 12 or that does not use the camera assembly 12 to actually take a picture. For example, the user may aim the electronic device 10 at an object or scene and, using an appropriate user interface, initiate the collection of point-of-view information, date information and time information. The point-of-view information, date information and time information may be transmitted to the server 40 for matching of this information to one or more images from the image database 44. Images identified by the picture sharing support function 42 may be transmitted back to the electronic device 10 as described in connection with the foregoing method. Alternatively, the matched images may be made available to the user at a later time for viewing, downloading and/or storing. In this manner, the electronic device 10 need not have a display 22. For example, the electronic device 10 may be a watch or pointer device that is used to capture information that may be matched to pictures from the image database 44.

The method may be beneficial to users with a low-quality camera assembly 12. For example, the alternative images that are presented to the user may have been taken with higher quality camera assemblies 12 and or with higher resolution. Therefore, using the method, the user may substitute his or her relatively low-quality image with a higher quality image. Also, in situations where illumination and/or weather conditions do not support that taking of a picture of the user's liking, the method may be used to obtain a more desirable image. As indicated above, the method also may be used to obtain an image that was taken at a different time of day or at a different time during the year. In one embodiment, the matching and/or prioritizing rules of block 64 may be relaxed or modified to enable the picture sharing support function 42 to identify images from the image database 44 that have a different point-of-view from the point-of-view of the camera assembly 12. This may allow for the identification of alternative images that have different viewing angles of the subject and/or images of the subject that were taken from different distances. This may allow the user to obtain images from other vantage points that may be of more interest to the user and/or that are not readily accessible to the user. In another embodiment, images from the same or similar location may be identified, but that were taken using a different direction. In this manner, a panoramic representation of the scene may be created. Depending on the available image content, the panoramic representation may be continuous or non-continuous.

It also will be appreciated that the above-described method is useful when the user is trying to capture an image of a static object or scene, such as a statue, a landscape, a building, or so forth. Pictures of people or moving objects may represent unique photography situations that may not be duplicated by matching point-of-view, date and/or time information against images stored by the image database 44. However, the method may be modified to replace a portion (e.g., background features) of a picture that is taken by the user. For example, user guided or automated pattern recognition may be used to identify foreground objects or other objects that may be unique to the user's picture 50, such as people, animals, cars, etc. If an image that matches the point-of-view is identified, the user may be provided with an option to replace the background of the user's picture 50 with image data from a user-selected alternative image 66. In one approach, the image data from the alternative image 66 may be scaled and objects that are recognized as foreground objects from the user's picture 50 may be superimposed on the alternative image 66 so as to create a new version of the user's picture. This new version will have components from the user's picture 50 and from the alternative image 66.

As indicated, the electronic device 10 of the illustrated embodiments is a mobile telephone. Features of the electronic device 10, when implemented as a mobile telephone, will be described with continued reference to FIGS. 1 through 3. The electronic device 10 is shown as having a “brick” or “block” form factor housing, but it will be appreciated that other housing types may be utilized, such as a “flip-open” form factor (e.g., a “clamshell” housing), a slide-type form factor (e.g., a “slider” housing) or a pivot-type (e.g., swivel) form factor.

As indicated, the electronic device 10 may include the display 22. The display 22 displays information to a user such as operating state, time, telephone numbers, contact information, various menus, etc., that enable the user to utilize the various features of the electronic device 10. The display 22 also may be used to visually display content received by the electronic device 10 and/or retrieved from a memory 90 of the electronic device 10. The display 22 may be used to present images, video and other graphics to the user, such as photographs, mobile television content and video associated with games.

The keypad 24 and/or buttons 26 may provide for a variety of user input operations. For example, the keypad 24 may include alphanumeric keys for allowing entry of alphanumeric information such as telephone numbers, phone lists, contact information, notes, text, etc. In addition, the keypad 24 and/or buttons 26 may include special function keys such as a “call send” key for initiating or answering a call, and a “call end” key for ending or “hanging up” a call. Special function keys also may include menu navigation and select keys to facilitate navigating through a menu displayed on the display 22. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, etc. Keys or key-like functionality also may be embodied as a touch screen associated with the display 22. Also, the display 22 and keypad 24 and/or buttons 26 may be used in conjunction with one another to implement soft key functionality. As such, the display 22, the keypad 24 and/or the buttons 26 may be used to control the camera assembly 12.

The electronic device 10 may include call circuitry that enables the electronic device 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to transmit, receive and/or process data, such as text messages, instant messages, electronic mail messages, multimedia messages, image files, video files, audio files, ring tones, signaling audio, signaling video, data feeds (including podcasts and really simple syndication (RSS) data feeds), and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 90, executing applications to allow user interaction with the data, displaying video and/or image content associated with the data, outputting audio sounds associated with the data, and so forth.

As indicated, the electronic device 10 may include the primary control circuit 30 that is configured to carry out overall control of the functions and operations of the electronic device 10. The control circuit 30 may be responsible for controlling the camera assembly 12.

The control circuit 30 may include a processing device 92, such as a central processing unit (CPU), microcontroller or microprocessor. The processing device 92 may execute code that implements the various functions of the electronic device 10. The code may be stored in a memory (not shown) within the control circuit 30 and/or in a separate memory, such as the memory 90, in order to carry out operation of the electronic device 10. In one embodiment, the processing device 92 may execute software that implements the picture sharing function 38.

Among other data storage responsibilities, the memory 90 may be used to store photographs and/or video clips that are captured by the camera assembly 12 and may store the alternative image(s) that are received from the server 40. Alternatively, a separate memory may be responsible for these data storage tasks. The memory 90 may be, for example, one or more of a buffer, a flash memory, a hard drive, a removable media, a volatile memory, a non-volatile memory, a random access memory (RAM), or other suitable device. In a typical arrangement, the memory 90 may include a non-volatile memory (e.g., a NAND or NOR architecture flash memory) for long term data storage and a volatile memory that functions as system memory for the control circuit 30. The volatile memory may be a RAM implemented with synchronous dynamic random access memory (SDRAM), for example. The memory 90 may exchange data with the control circuit 30 over a data bus. Accompanying control lines and an address bus between the memory 90 and the control circuit 30 also may be present.

Continuing to refer to FIGS. 1 through 3, the electronic device 10 includes an antenna 94 coupled to a radio circuit 96. The radio circuit 96 includes a radio frequency transmitter and receiver for transmitting and receiving signals via the antenna 94. The radio circuit 96 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 94 and the radio circuit 96 may represent one or more than one radio transceivers.

The electronic device 10 further includes a sound signal processing circuit 98 for processing audio signals transmitted by and received from the radio circuit 96. Coupled to the sound processing circuit 98 are a speaker 100 and a microphone 102 that enable a user to listen and speak via the electronic device 10 as is conventional. The radio circuit 96 and sound processing circuit 98 are each coupled to the control circuit 30 so as to carry out overall operation. Audio data may be passed from the control circuit 30 to the sound signal processing circuit 98 for playback to the user. The audio data may include, for example, audio data from an audio file stored by the memory 90 and retrieved by the control circuit 30, or received audio data such as in the form of streaming audio data from a mobile radio service. The sound processing circuit 98 may include any appropriate buffers, decoders, amplifiers and so forth.

The display 22 may be coupled to the control circuit 30 by a video processing circuit 104 that converts video data to a video signal used to drive the display 22. The video processing circuit 104 may include any appropriate buffers, decoders, video data processors and so forth. The video data may be generated by the control circuit 30, retrieved from a video file that is stored in the memory 90, derived from an incoming video data signal that is received by the radio circuit 96 or obtained by any other suitable method. Also, the video data may be generated by the camera assembly 12 (e.g., such as a preview video signal to provide a viewfinder function for the camera assembly 12).

The electronic device 10 may further include one or more I/O interface(s) 106. The I/O interface(s) 106 may be in the form of typical mobile telephone I/O interfaces and may include one or more electrical connectors. As is typical, the I/O interface(s) 106 may be used to couple the electronic device 10 to a battery charger to charge a battery of a power supply unit (PSU) 108 within the electronic device 10. In addition, or in the alternative, the I/O interface(s) 106 may serve to connect the electronic device 10 to a headset assembly (e.g., a personal handsfree (PHF) device) that has a wired interface with the electronic device 10. Further, the I/O interface(s) 106 may serve to connect the electronic device 10 to a personal computer or other device via a data cable for the exchange of data. The electronic device 10 may receive operating power via the I/O interface(s) 106 when connected to a vehicle power adapter or an electricity outlet power adapter. The PSU 108 may supply power to operate the electronic device 10 in the absence of an external power source.

The electronic device 10 also may include a system clock 110 for clocking the various components of the electronic device 10, such as the control circuit 30 and the memory 90.

The electronic device 10 also may include a local wireless interface 108, such as an infrared transceiver and/or an RF interface (e.g., a Bluetooth interface), for establishing communication with an accessory, another mobile radio terminal, a computer or another device. For example, the local wireless interface 108 may operatively couple the electronic device 10 to a headset assembly (e.g., a PHF device) in an embodiment where the headset assembly has a corresponding wireless interface.

Although certain embodiments have been shown and described, it is understood that equivalents and modifications falling within the scope of the appended claims will occur to others who are skilled in the art upon the reading and understanding of this specification.

What is claimed is:

1. A method of sharing a digital image, comprising:
receiving point-of-view information that indicates a relationship between an electronic device and a scene, the point-of-view information including location information for the electronic device and aiming direction information for the electronic device; and
searching an image database for an image that is associated with a point-of-view that corresponds to the point-of-view information for the electronic device.

2. The method of claim 1, further comprising transmitting an image from the image database to the electronic device, the transmitted image associated with a point-of-view that corresponds to the point-of-view information for the electronic device.

3. The method of claim 1, wherein the direction information includes a compass direction and an elevation.

4. The method of claim 1, wherein the point-of-view information further includes altitude information for the electronic device.

5. The method of claim 1, further comprising receiving date information from the electronic device and the searching includes searching the image database for an image that has an associated date that corresponds to the received date information.

6. The method of claim 1, further comprising receiving date information from the electronic device and the searching includes searching the image database for an image that has an associated date that is different than the received date information so that a matched image of the scene has potential to have noticeably different visual attributes.

7. The method of claim 1, further comprising receiving time of day information from the electronic device and the searching includes searching the image database for an image that has an associated time of day that corresponds to the received time of day information.

8. The method of claim 1, further comprising receiving time of day information from the electronic device and the searching includes searching the image database for an image that has an associated time of day that is different than the received time of day information so that a matched image of the scene has potential to have noticeably different visual attributes.

9. The method of claim 1, further comprising maintaining a user selection score for each image of the image database and the searching including prioritizing search results based on the corresponding user selection scores.

10. The method of claim 1, further comprising receiving an image of the scene and point-of-view information associated with the image from the electronic device and adding the image and associated point-of-view information to the image database.

11. A method of obtaining a digital image with an electronic device, comprising:
generating point-of-view information that indicates a relationship between the electronic device and a scene, the point-of-view information including location information for the electronic device and aiming direction information for the electronic device;
transmitting the point-of-view information to a server that searches an image database for an image that is associated with a point-of-view that corresponds to the point-of-view information for the electronic device; and
receiving the digital image from the server, the received image having an associated point-of-view that corresponds to the point-of-view information generated by the electronic device.

12. The method of claim 11, wherein the direction information includes a compass direction and an elevation.

13. The method of claim 11, wherein the point-of-view information further includes altitude information for the electronic device.

14. The method of claim 11, further comprising transmitting at least one of date information or time of day information to the server.

15. The method of claim 11, wherein multiple images are received from the server and the method further includes selecting one or more of the images for storage.

16. The method of claim 11, further comprising taking a digital picture of the scene with the electronic device.

17. The method of claim 16, further comprising substituting the digital picture taken with the electronic device with the received image.

18. The method of claim 16, further comprising transmitting the digital picture taken with the electronic device to the server.

19. The method of claim 16, further comprising combining image data from the digital picture taken with the electronic device with image data from the received image to generate a composite image.

20. The method of claim 19, wherein the image data from the digital picture taken with the electronic device present in the composite image is recognized as corresponding to objects that are unique to the digital picture taken with the electronic device.

21. The method of claim 11, wherein the electronic device includes a camera assembly.

22. The method of claim 11, wherein the electronic device does not include a camera assembly.

23. An electronic device, comprising:
one or more components that output data relating to a point-of-view of the electronic device;
a radio circuit used to establish a wireless interface with a network to exchange data with a server; and
a controller that:
generates point-of-view information from the data of the one or more components, the point-of-view information indicative of a relationship between an electronic device and a scene, and the point-of-view information including location information for the electronic device and aiming direction information for the electronic device; and
controls the radio circuit to transmit the point-of-view information to the server for the server to conduct a search of an image database for an image that is associated with a point-of-view that corresponds to the point-of-view information for the electronic device; and
wherein the electronic device receives a digital image from the server, the received image having an associated point-of-view that corresponds to the point-of-view information generated by the controller.
